(19) United States
(12) Patent Application Publication
(10) Pub. No.: US 2016/0085832 A1
(43) Pub. Date: Mar. 24, 2016

(54) System and method of analyzing data using bitmap techniques

(71) Applicant: RICHARD L LAM, Pleasanton, CA (US)

(72) Inventor: RICHARD L LAM, Pleasanton, CA (US)

(21) Appl. No.: 14/494,609

(22) Filed: Sep. 24, 2014

(51) Int. Cl. G06F 17/30

(52) U.S. Cl. CPC G06F 17/30554; G06F 17/30424

(57) ABSTRACT

A method and system of analyzing data using bitmap techniques by first transforming source data records to key-value pairs, then selecting required attributes within said data source to create bitmap segments that are associated to the attribute's corresponding data records, where data analyses are performed by mean of formulating and executing required Set (or bit-wise) operations among the required bitmap segments to generate a final result bitmap segment, and based on which retrieving the corresponding result set of data records and perform further analyses by applying statistical and/or user-defined functions on the result set to generate the required result.

### REFERENCED CITED

U.S. Patent Documents

| | | |
|---|---|---|
| 5,359,724 | Oct. 25, 1994 | Earle |
| 7,315,849 | Jan. 1, 2008 | Bakalash, et al. |
| 7,590,620 | Sep. 15, 2009 | Pike, et al. |
| 7,689,630 | Mar. 30, 2010 | Lam |

### TECHNICAL FIELD

The present invention relates to data processing systems and methods using bitmap based techniques, more particularly, to simplify accessing and analyzing data records to generate required result.

### DIAGRAMS

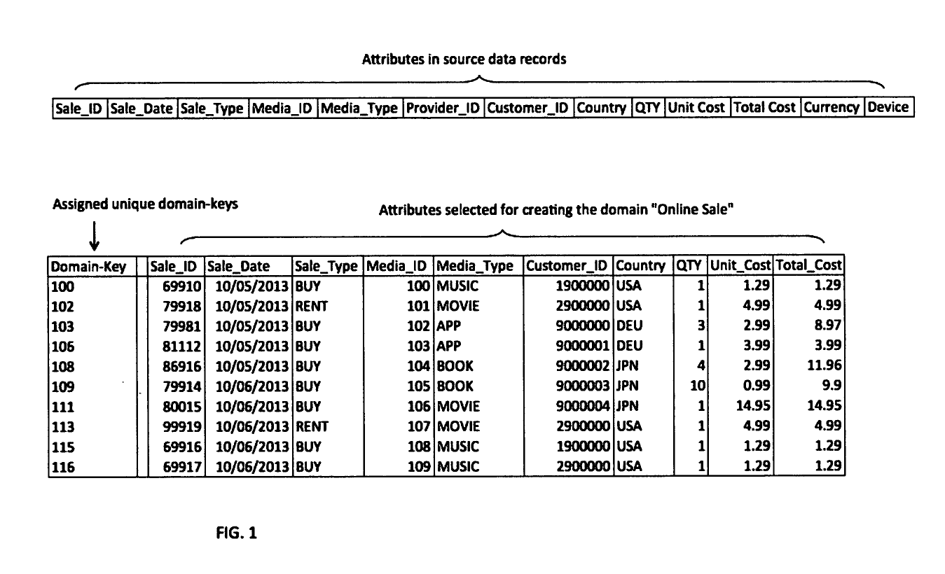

FIG. 1 is a diagram showing a domain is created based on sample data records of online sale transactions for analyses.

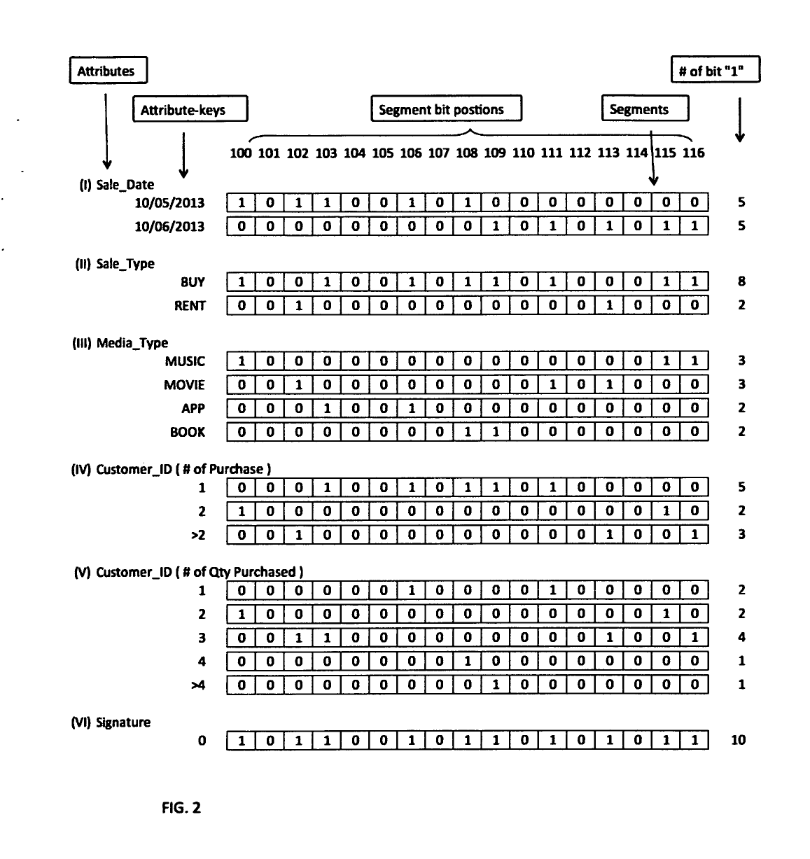

FIG. 2 is a diagram showing various types of attribute-keys and their corresponding segments are created as part of its domain.

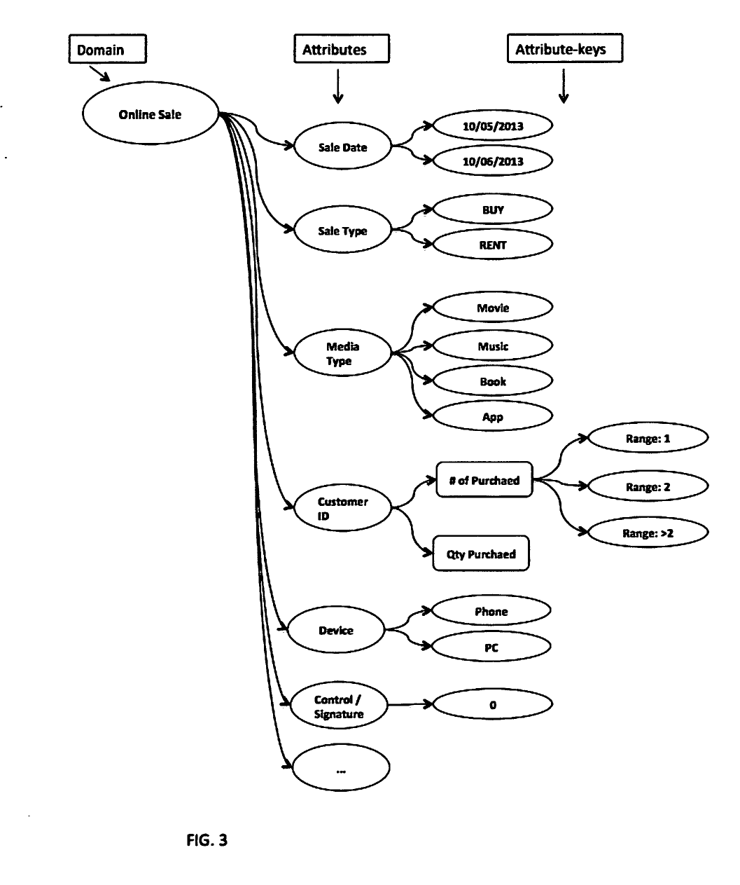

FIG. 3 is a diagram showing the sample domain with its attributes, attribute-keys represented in a tree-like graph.

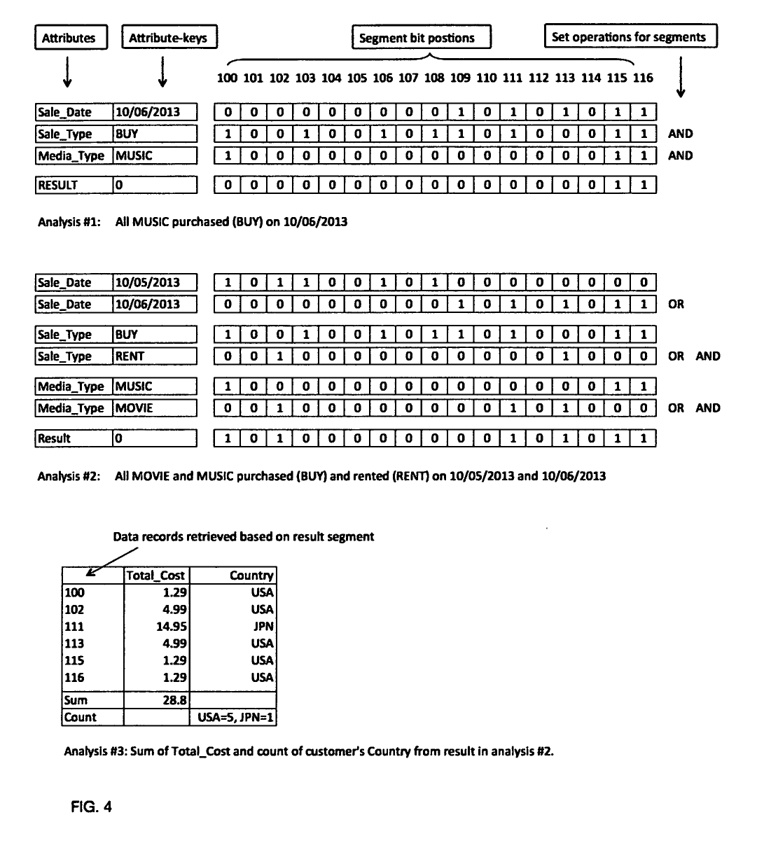

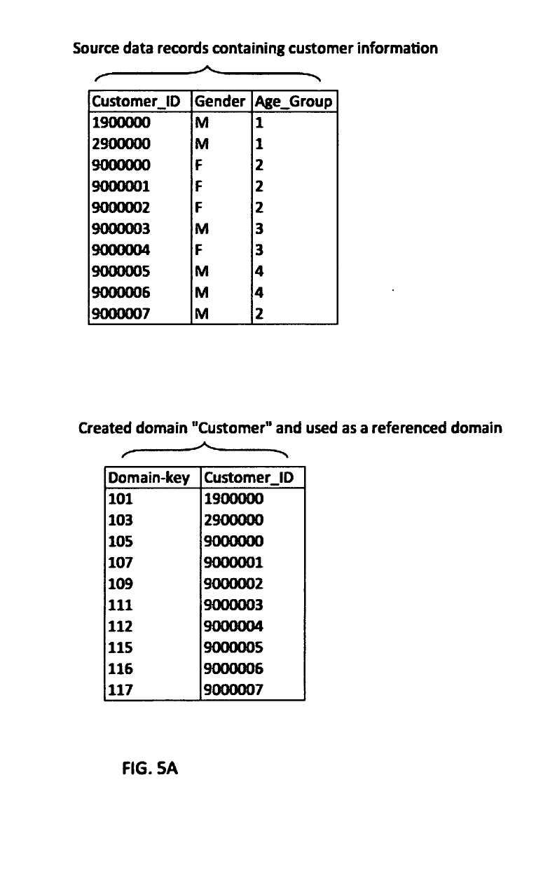

FIG. 4 is a diagram showing sample analyses performed by executing formulated Set operations among the required segments.

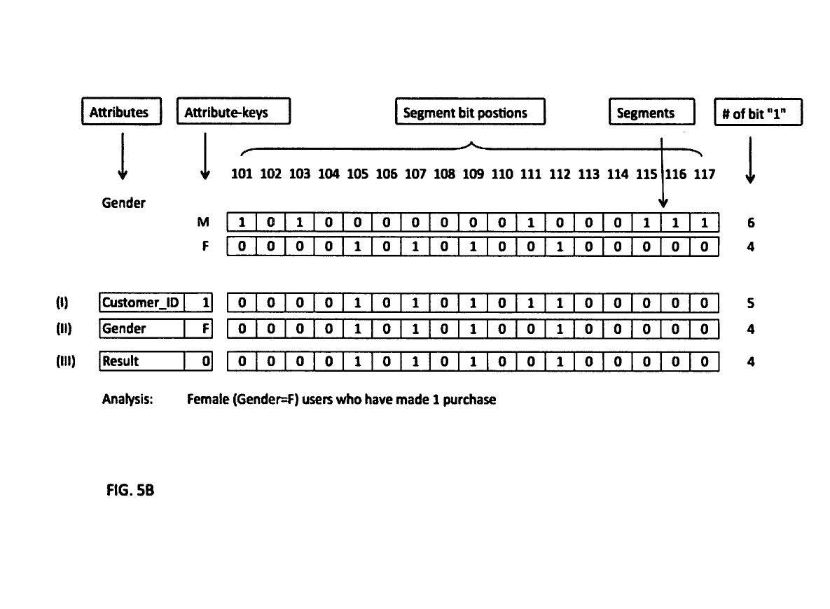

FIG. 5A is a diagram showing a domain is created based on sample data records of customer information and is used as a referenced domain.

FIG. 5B is a diagram showing a converted segment is used for performing Set operations with an existing segment in the referenced domain.

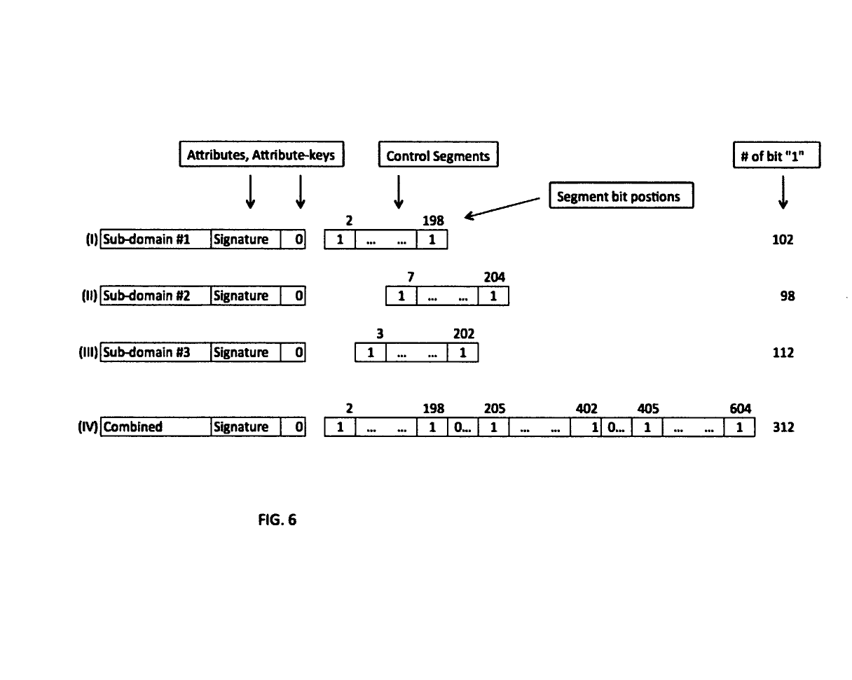

FIG. 6 is a diagram showing a combined signature segment is generated from an ordered list of sub-domains' signature segments.

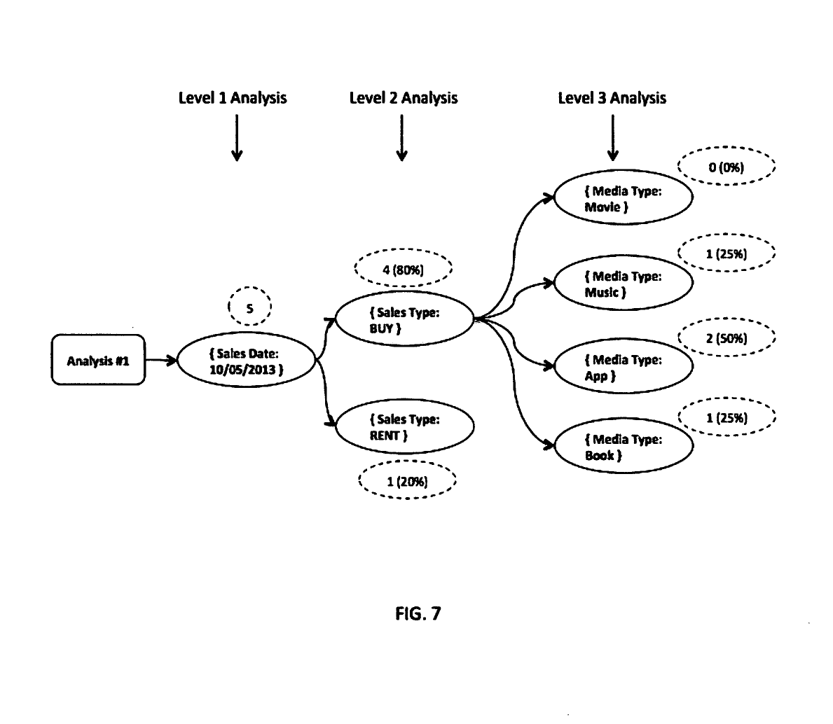

FIG. 7 is a diagram showing an example of the multi-level drill-down data profiling analysis represented in a tree-like graph.

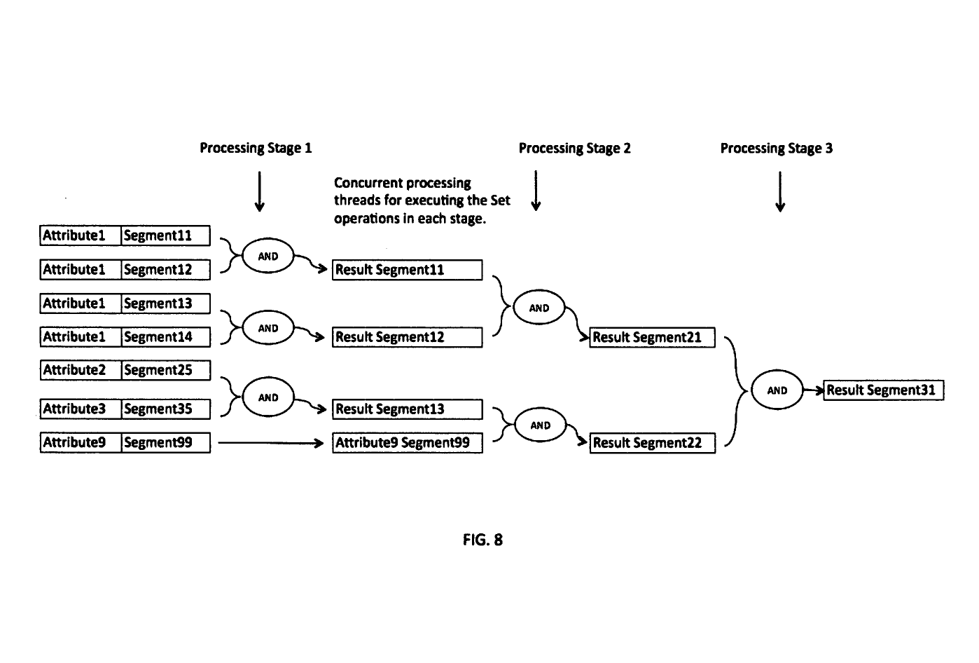

FIG. 8 is a diagram showing an example of executing Set operations for a list of segments in parallel by concurrent processing threads.

### BACKGROUND OF THE INVENTION

For Large-scale data processing for analytical purposes, the likes of relational database such as Oracle, and various parallel processing systems such as Hadoop, save source data to its own data store and enable data query access via SQL and executing MapReduce jobs, respectively.

For the former, knowledge of SQL is required; secondly, query performance is dependent on tuning the SQL statement based on knowledge of inner working of the database to enable the system to choose the optimal execution path, and if otherwise not chosen, poor performance and even failure could be resulted.

For the later, MapReduce jobs are executed in a cluster of servers where performance is dependent on complex system-wide resource coordination and optimization among all the servers, and performance could be severely impacted due to disks and other hardware failures on just one or a few nodes of the cluster.

This invention simplifies the process of accessing and analyzing data by reorganizing the source data records, of which are organized with pre-defined attributes, and creating bitmap segments for the respective attributes where analyses are performed by mean of formulating and executing Set (or bit-wise) operations among the said bitmap segments to generate a result segment that provides meaningful information, for example, as required key performance indicators.

Said bitmaps, in general, are much smaller in size and will be cached in memory for said Set operations execution, which are low-level bit-wise operations that can be executed efficiently by high-speed processors including, but not limited to, CPU and/or GPU, in parallel via multithreaded processing where performance is scalable with increasing number of processors, its processing cores, and/or its speed.

### SUMMARY DESCRIPTION OF THE INVENTION

A system and method of organizing and analyzing large-scale data records, of which are organized with pre-defined attributes, by first transforming said data records into key-value pairs, then for each required attribute, creating one or more attribute-keys, and for each attribute-key, creating a corresponding bitmap segment (refer to Lam, U.S. Pat. No. 7,689,630 or others), which hereon is referred as a “segment”. Analyses are performed by mean of formulating and executing respective Set (or bit-wise) operations among the required segments to generate the final result segment.

Further analyses can be performed by retrieving the result set of data records using the bit information from the result segment and applying required filtering, aggregating, statistical, and/or user-defined functions on the retrieved records to generate the required result.

The said transformed set of data records in key-value pairs, its corresponding attributes, attribute-keys, and segments are collectively maintained as a single entity, which hereon is referred as a “domain”. The system maintains a collection of domains.

Other aspects of the invention include the ability of maintaining a domain for adding new data records to or deleting existing ones from it, ability of converting segments that belong to one domain to be compatible with another domain so Set operations can be performed across domains, ability of maintaining one or more child domains for a parent domain where analyses can be performed on the individual child domains or one that combined the respective child domains, and others.

### DETAILED DESCRIPTION OF THE INVENTION

Domain and Its Components Creation

Given a set of source data records, of which is organized with pre-defined attributes, in this example, R with attribute from AA, AB to AY:
R={AA, AB, AC, AD, AE, . . . AY}

where each attribute contains its own defined set of values and each source data record is consisted of a combination of values from the respective attributes.

In this example, the first and last distinct value for attribute AA, AB, AC, . . . , AY are AA(1) to AA(m), AB(1) to AB(g), AC(1) to AC(h), . . . , AY(1) to AY(k), respectively, and R contains:

$$R ( 1 ) = \{ AA ( 1 ) , AB ( 1 ) , A C ( 1 ) , … AY ( 1 ) \}$$

$$R ( 2 ) = \{ AA ( 2 ) , AB ( 3 ) , A C ( 2 ) , … AY ( 10 ) \}$$

$$…$$

$$R ( 31364 ) = \{ AA ( 168 ) , AB ( g ) , A C ( h ) , … AY ( k ) \}$$

$$…$$

$$R ( n ) = \{ AA ( m ) , AB ( 50 ) , A C ( 2 ) , … AY ( 100 ) \}$$

where R(1) to R(n) correspond to the first to the last data record of R; a large-scale set of source data records will have one or more large attributes and/or high number of permutations among them.

The method of creating a said domain for analyses is comprising of:

1) selecting all or a subset of the attributes from the source data records based on the requirements of the analyses, then creating key-value pairs for all the data records by generating an unique identifier and assigning to each corresponding data record, which is consisted of attribute values from said selected attributes, wherein each said unique identifier hereon is referred as a “domain-key”.
In this example, attribute AA, AB, and AC are selected for creating the domain:

$$D ( 1 ) = K ( 1 ) , \{ AA ( 1 ) , AB ( 1 ) , A C ( 1 ) \}$$

$$D ( 2 ) = K ( 2 ) , \{ AA ( 2 ) , AB ( 3 ) , A C ( 2 ) \}$$

$$…$$

$$D ( 31364 ) = K ( 31364 ) , \{ AA ( 168 ) , AB ( g ) , A C ( h ) \}$$

$$…$$

$$D ( n ) = K ( n ) , \{ AA ( m ) , AB ( 50 ) , A C ( 2 ) \}$$

where D(1) to D(n) are the domain's data records, which are consisted of unique domain-key K(1) to K(n) and the respective attribute values from the selected attributes AA, AB, and AC.
FIG. 1 shows a domain is created for a sample set of online sale transaction records for media such as movies purchased and rented by customers; for this domain, the subset of attributes selected include Sale_ID, Sale_Date, Sale_Type, Customer_ID, Country, Qty, Unit_Cost, and Total_Cost; unique domain-keys are generated and assigned to the source data records.

2) for each required attribute, creating and associating to it the required one or more attribute-keys, which include, but not limited to, the types below, and for each attribute-key, creating the corresponding segment:
(a) a single value from one of the attribute's distinct values:
   creating the attribute-key and associating to it the said distinct attribute value;
   creating the corresponding segment for the said attribute-key, wherein setting the segment's all bit positions equal to the domain-keys of the data records corresponding to the said attribute-key to “1” (or “on”), and setting the rest of the bits to “0” (or “off”).
(b) a set of qualified values from the attribute's distinct values:
   creating the attribute-key to associate to a set of qualified values, wherein the attribute-key is also associated to the corresponding range partition that has a start and end range value; for an attribute value to be qualified to the said range partition, the result of applying pre-defined statistical and/or user-defined functions on the set of data records corresponding to the said attribute value and, if applicable, in relation to all or a subset of the domain's data records, falls within the said partition range; the said functions can be applied to the values of the same and/or different attributes;
   creating the corresponding segment for the said attribute-key, wherein setting the segment's all bit positions equal to the domain-keys of the data records corresponding to the qualified set of attribute values to “1”, and setting the rest of the bits to “0”;
   the parent attribute will be correspondingly associating to the list of consecutive non-overlapping range partitions associated with its respective attribute-keys.
   For example, given the qualifying function is the count of occurrences of an attribute value's corresponding data records falls within the defined set of range partitions shown below:
      attribute-key1 for range {1 to 5}
      attribute-key2 for range {6 to 10}
      attribute-key3 for range {11 to 15}
      attribute-key4 for range {>15}
   then an attribute value with occurrences between 1 and 5 times will be qualified for and assigned to attribute-key1, and those with occurrences between 6 to 10 times to attribute-key2, and so forth, and those with occurrences greater than 15 times to attribute-key4.
(c) a defined value with a defined corresponding set of data records:
   creating the attribute-key to associate to one or a set of the defined values;
   creating the corresponding segment for the attribute-key, wherein setting the segment's all bit positions equal to the domain-keys of the said defined data records to “1”, and setting the rest of the bits to “0”.
   This is a general case of (a) and (b); it is used for, but not limited to, creating intermediate result segments from Set operations and control segments:
For attributes in source data records but not selected for the domain, corresponding attribute-keys and segments can still be created using the same process and be included as part of the domain.
FIG. 2 shows the various types of attribute-keys and their corresponding segments are created: (I), (II), and (III) for single attribute value via method (a) above; (IV) and (V) for set of qualified values via method (b); and (VII) for a defined value via method (c). In FIG. 2, for all the segments, only the portion of the bitmap that includes the range of bits for the domain-keys are shown.
For (I), attribute Sale_Date is consisted of two attribute-keys: “Oct. 05, 2013” and “Oct. 06, 2013”, which correspond to domain-keys of {100, 102, 103, 106, 108} and {109, 111, 113, 115, 116}, respectively; their corresponding segments with bit positions respective to their domain-keys are set to “1” accordingly.

For attribute Customer_ID, two separate groups of attribute-keys are created, where (IV) is based on the total count of purchases by a Customer_ID value, and (V) is based on total sum of values for attribute “Qty” by a Customer_ID value.
For (IV) and the attribute-key associated with range partition name of “1”, its segment's bits are set to “1” for positions equal to the qualified values' domain-keys of {103, 106, 108, 109, 111}, where the respective qualified customer_ID values are {9000000, 9000001, 9000002, 9000003, 9000004}.
For (V) and the attribute-key associated with range partition of “1”, its segment's bits are set to “1” for positions equal to the qualified values' domain-keys of {106, 111}, where the respective qualified customer_ID values are {9000001, 9000004}.
For (VI), attribute Signature is consisted of an attribute-key with a defined value of 0, and it is associated to a control segment that corresponds to all of domain's data records.
FIG. 3 shows a tree-like representation for a domain's hierarchical structure, which is consisted of its attributes and attribute-keys; segments are not shown but it is implied that each attribute-key is associated with its corresponding segment. The system maintains one or more domains, where each has its own hierarchical structure.

3) performing the analyses by selecting the required segments and formulating the required filtering, aggregating, and/or other computational logics into respective one or more Set operations in the required execution order, and executing the Set (or bit-wise) operations among the segments to generate a final result segment, wherein intermediate result segments may be generated and used as input operands to subsequent Set operations.
performing further analyses by retrieving the corresponding result data records by matching the domain-keys equal to the bit “1” positions of the final result segment for looking up values for the same and/or different attributes, then applying additional statistical and/or user-defined functions to the said retrieved data records for generating the required result.
FIG. 4. shows sample analyses performed by formulating and executing the required Set operations among the required segments.
Analysis #1 requires finding the data records corresponding to all music items purchased on a specific date of Oct. 05, 2013. The required segments and respective Set operations are:
   {Sale_Date:Oct. 06, 2013} AND {Sale_Type:BUY} AND {Media_Type:MUSIC}
where the notation of {attribute: attribute-key} is used.
The result segment shows that 2 data records satisfy the criteria, as indicates by its bit “1” positions of {115, 116}, which correspond to the same domain-keys.
Analysis #2 requires finding the data records corresponding to all movie and music items purchased or rented on Oct.05, 2013 and Oct. 06, 2013. The required segments and respective Set operations are:
   {Sale_Date:Oct. 05, 2013} OR {Sale_Date :Oct. 06, 2013}
   AND
   {Media_Type:MUSIC} OR {Media_Type:MOVIE}
   AND
   {Sale_Type:BUY} OR {Sale_Type:RENT}
The result segment shows that 6 data records satisfy the criteria, as indicates by its bit “1” positions of {100, 102, 111, 113, 115, 116}, which correspond to the same domain-keys.
Analysis #3 shows further analysis is performed by retrieving the result data records based on the result segment's bit information from Analysis #2, which include {100, 102, 111, 113, 115, 116}, and applying a sum function to the corresponding attribute values for “Total_Cost” to obtain the total cost amount of $28.8; furthermore, “Country” information is also extracted from the same result records to obtain that 5 items are purchased by customers from USA and 1 item from JPN.

Domain Conversion for Segments

In general, segments created for the same domain have the same “gain” and can perform Set operations with one another without restriction, but that will not work across different domains unless the segment is explicitly converted to be compatible with the other domain.

For a subset of the attributes of a domain (originating) that has the same attribute structure of a different domain (referenced), a segment from the originating domain can be converted to be compatible with the referenced domain, wherein new analyses, that would otherwise not possible from the originating domain, can be performed to generate insights by performing Set operations using the converted segment with all the available segments, which include existing and new to be created in future, for the referenced domain, the detail steps for converting a segment are comprising of:
for the originating segment, extracting its corresponding data records with domain-keys equal to the bit “1” positions of the segment;
for the said extracted data records, extracting the values from the respective set of attributes and applying the same unique-key generation method by the referenced domain to create the corresponding new key-value pairs;
creating the new, or converted, segment for the referenced domain based on the domain-keys of the new key-value pairs.

FIG. 5A shows a sample set of source data records of customer information for which a domain “Customer” is created, with one selected attribute “Customer_ID” and two attribute-keys based on “Gender” values of “M” and “F” and their corresponding segments.

In this example for segment conversion using attribute Customer_ID, the originating domain is “Online Sale” in FIG. 1 and the referenced domain is “Customer” in FIG. 5A.

FIG. 5B shows segment (I), which is converted from the originating domain's attribute-key (IV) with {Customer_ID (# of Purchase) : range partition “1”} in FIG. 2 to the referenced domain, and performed a Set operation “AND” with an existing segment (II):{Gender: “F”} to generate the result segment (III) which consists of 4 bit “1”s. The result indicates that among the 5 sale transactions in (IV) from the originating domain, 4 are made by female customers, or customers with Gender value of “F”.

From the said originating segment for attribute-key (IV), Customer_ID values of {9000000, 9000001, 9000002, 9000003, 9000004} are extracted based on the corresponding domain-keys of {103, 106, 108, 109, 111}; in the referenced domain, the respective domain-keys generated for the same of set of Customer_ID values are {105, 107, 109, 111, 112}, based on which segment (I) was created.

Domain Insert and Delete

A special type of control segment, which hereon is referred as “signature”, is created for associating to all of the domain's data records. New data records can be inserted to and existing ones can be deleted from a domain. The domain maintains its net data records by mean of creating and maintaining the respective versions of its signature segments, the detail steps are comprising of:

for inserting new data records,
applying the same domain-key generation method for creating new key-value pairs for the new data records;
creating a temporarily control segment that is associated to all the new data records;
performing Set operation UNION (or “OR” bit-wise) for the current signature segment and the temporarily control segment to create a new signature segment that reflects the new combined set of data records.

for deleting existing data records,
creating a temporarily control segment that is associated to all the existing data records for deleting; performing Set operation “MINUS” (or “MINUS” bit-wise) for the current signature segment with the said temporarily control segment to create a new signature segment that reflects the net set of data records, with the deleting data records subtracted from the previously full set.

Each version of the signature segment is maintained, and which can be saved to and retrieved from disk. Analyses that require applying filtering and/or other computation logics to the full set of data records of the domain will perform the required Set operations with the required version of the signature segment and the respective attribute segments.

Sub-Domains and Domain-Shift

A domain can be associated to one of more child domains, where each having the same attribute structure as its parent; a said child domain hereon is referred as a “sub-domain”. A sub-domain is used, but not limited to, as a data partition for new set of data records to be added on a periodic basis, for example, creating a new sub-domain for each new day's data records.

A sub-domain can either generate its own range of domain-keys independent of other sub-domains of the same parent, or adhere to a defined range assigned by its parent. Attributes, attribute-keys, and segments created for a sub-domain are based on its own domain-keys.

In general, sub-domains provides better performance for storing and retrieving data records to and from disk due to the individual sub-domain size is smaller; furthermore, segments created for sub-domains would have smaller size as the bit range would be smaller compare to an end-to-end range of a single domain.

An ordered list of two or more sub-domains can be combined into a single domain for analyses by creating a new signature segment that combine the signature segments of the respective sub-domains, the detail steps are comprising of:
starting from the second till the last signature segment in the list, up-shifting, or incrementing, all the bits in each respective signature segment by an offset value equals to the maximum bit position value of its immediate previous signature segment that has been up-shifted or otherwise use the original non-shifted if not applicable (for example, the first segment);
then performing Set operation UNION (or “OR” bit-wise) among the signature segments, starting from the first non-shifted through each in-between till the last up-shifted signature segment, to generate the final signature segment that reflects the combined sub-domains.

FIG. 6 shows a ordered list of signature segments of (I) with a bit range of 2 and 198; (II) with 7 and 204; and (III) with 3 and 202, and their bit “1” count are 102, 98, and 112, respectively.

After combining, (II) is up-shifted by an offset of 198 to all its bits and resulted in a new range of 205 and 402; and (III) is up-shifted by an offset of 402 and resulted in a new range of 405 and 604. The bit “1” count in the final combined signature segment is equal to the sum of bit “1” of the signature segments in the list, which is 312 (equals to 102+98+112) for this example.

A same ordered list of corresponding attribute segments from the respective sub-domains can be combined using the same said method, where the up-shifted offset value is based on their corresponding up-shifted signature segments or on non-shifted if not applicable.

A new result attribute segment created from Set operations among the combined segments can be converted back to segments that would conform to the respective sub-domains, the detail steps are comprising of:
first creating a new segment for each sub-domain and copying to the new segment the bits within the respective range for the corresponding sub-domain from the combined segment;
then down-shifting, or decrementing, the bits in each of the new segment by the same offset value that was used previously for combining the segment of this sub-domain to the final combined segment.

For the example in FIG. 6, the conversion from a combined segment back to the respective sub-domain segments will use the range of 205 and 402 for (II), and 405 and 604 for (III).

Data Profiling With Multi-Level Drill-Down

Analyses for data profiling can be performed by selecting a target attribute-key and performing the required Set operations for it with a required set of source attribute-keys from one or more of other attributes.

For the purpose of analyses, the target attribute-key carries a score, a count of bit “1” for its segment. The said data profiling action of executing the Set operations with the respective source attribute-keys generate a new set of scores for the source attribute-keys based on their respective result segments' count of bit “1”, wherein the respective scores can be used as performance indicators for comparison analyses and decision support. The source attribute-key and its result segment herein is referred as “profiled attribute-key”.

Additional performance indicators can be generated by preforming statistical and/or user-defined functions with the scores of the target and that of the profiled attribute-keys; for example, generating the percent for each profiled attribute-key's score relative to the target's score:
relative percent of profiled attribute-key (i)=score of profiled attribute-key(i)/score of target attribute-key

where (i) ranges from 1 to the last profiled attribute-key.

The said data profiling analyses can continue on to the next level and indefinitely by selecting the one required profiled attribute-key as the next target attribute-key, and repeating the same process by applying the same or different required Set operations with another selected set of source attribute-keys against the said selected target.

FIG. 7 is a diagram showing one example of the multi-level drill-down data profile analysis using a tree-like representation, where the sample data is based on the domain and corresponding attribute-keys created in FIG. 1 and FIG. 2.

For the first level of profiling, the target attribute-key is {Sale_Date: Oct. 05, 2013}, which is associated to 5 transactions, or a score of 5, and the set of source attribute-keys selected include {Sale_Type: BUY} and {Sale_Type: RENT}. The profiled attribute-key scores are 4 and 1 and the relative percent are 80% and 20%, respectively.

For the next or second level of profiling, the target selected is the profiled attribute-key {Sale_Type: BUY}, which has a score of 4, and the source attribute-keys selected include {Media_Type: Movie, Music, App, and Book}. The resulting scores for this profiling action are 0, 1, 2, and 1 and the relative percent are 0%, 25%, 50%, and 25%.

The said analyses are based on the scores of the individual profiled attribute-keys. A variation of the analyses can be based on the end-to-end path of the multi-level drill-down, starting from first target to the last profiled attribute-key. The last profiled score can be defined, but not limited to, as the score for the path.

For the example in FIG. 7, the path with the highest score is 2, with the sequence of {Sale_Date: Oct. 05, 2013}, {Sale_Type: BUY}, {Media_Type: App}.

Segment Set Operations Executed in Parallel

One or more Set operations executing among a list of segments, wherein the final result segment is not affected by the order sequence of said particular executions, can be performed in parallel by a plurality of processors, wherein the detail steps are comprising of:
grouping the list of segments in pairs for its respective Set operation; for a list with odd number of segments leave the last segment as is un-paired;
for each said pair of segments, allocating a separate processing thread to execute the Set operation in parallel, where each said Set operation will generate a result segment;
adding the said result segments to a new list; also adding the un-paired segment from the previous list, if any, to the new list;
repeat the same process of executing Set operations in parallel for this new list of grouped segments, which in turn will generate a new set of result segments; continue the process till a final segment is generated.

The overall processing will be performed in stages, where the initial stage having a static list of segments and all subsequent stages having result segments arriving in an asynchronous manner. For each processing stage, new concurrent processing threads will be created to process the Set operation for each pair of segments after they have arrived and are ready to be processed. Modern CPU supports multi-threaded processing via its many processing cores which can range from 2 to 16 or higher, whereas GPU can have processing cores in the thousands.

FIG. 8 shows the execution of Set operations for a sample list of segments by concurrent processing threads. In this example, the initial list have 7 segments and therefore require 3 stages to generate the final result segment; for the processing stage 1, 2, and 3, the concurrent processing threads for the respective stage are 3, 2, and 1.

What is claimed is:

1. A computer-implemented method of organizing and analyzing data records using bitmap based techniques, wherein said collection of source data records is organized with one or more attributes, comprising:
selecting all or a required subset of said attributes based on requirements of the analyses;
creating a key-value pair for each said data record by assigning it with an unique integer identifier;
for an said attribute, creating one of more required “attribute-keys”, wherein a said attribute-key is one of its attribute's distinct value; or a qualified subset of said attribute's distinct values which satisfy the criteria that the numeric result of applying pre-defined statistical and/or user-defined functions to its corresponding data records falls within a pre-defined numeric range; or a defined value along with a defined set of corresponding data records;
for each said attribute-key, creating and associating to it a bitmap segment (refer to Lam, U.S. Pat. No. 7,689,630 or others), wherein setting said bitmap segment's bit positions that are equal to the unique identifier of said attribute-key's corresponding data records to “1” (“on”) and setting all other bit positions to “0” (“off”);
performing data analyses by mean of formulating and executing Set (respective bit-wise) operations among said bitmap segments of same and/or different attributes to generate a final result bitmap segment, or as an intermediate result and use as an input operand for subsequent operations to generate the final result;
performing lookup for said and/or other related attributes for further processing by retrieving data records based on matching said data records' unique identifiers to bit “1” positions of said final result segment;
extracting required attributes from said retrieved data records and applying filtering, aggregating, and/or statistical functions to generate required result;
wherein said data records organized in key-value pairs, attributes, attribute-keys, and corresponding bitmap segments collectively are maintained as a single entity, wherein said entity hereon is referred as a “domain” with an assigned unique name, and the domain's key-value pairs are referred as “domain-records”, the keys in said key-value pairs are referred as “domain-keys”, and said bitmap segments are referred as “segments”, wherein one or more domains are maintained in a system.

2. The method of claim 1, wherein a said domain, along with its components including its domain-records, attributes, attribute-keys, segments, metadata, and other required information can be saved to and retrieved from president disk based file-system storage, wherein compression and respective de-compression can be applied to said segments before saving to disk and after retrieving for Set and other operations.

3. The method of claim 1, wherein for an attribute that is part of said collection of source data records but is not included to said domain, one or more attribute-keys and corresponding segments can still be created based on said attribute using same said method.

4. The method of claim 1, wherein a subset of attributes in a domain having the same attribute structure of a different domain, wherein values from said respective attributes are common and have same meaning in both domains, wherein said domains hereon are referred as “originating” and “referenced” domain, respectively, wherein a method of converting any segments created in a said originating domain to a new segment that will conform to a said corresponding referenced domain, wherein said new segment can be used in Set operations with existing and future available segments in said referenced domain, comprising:
for a segment in said originating domain, retrieving its corresponding domain-records based on matching the domain-keys equal to said segment's bit “1” position values;
extracting said subset of attributes from said retrieved domain-records, which will have same attribute structure as that of said referenced domain;
creating new key-value pairs for said interim set of data records using the same unique key generation method by said referenced domain;
creating said new, or converted, segment for said referenced domain from said interim set of data records.

5. The method of claim 1, wherein a said type of attribute-key that corresponds to a qualified set of its attribute's distinct values is also associating to a corresponding pre-defined range partition that has a start and end range value, wherein for an attribute value to be qualified to said attribute-key, or said range partition, the result of applying pre-defined statistical and/or user-defined functions on the set of domain-records corresponding to said attribute value and, if applicable, in relation to all or a subset of said domain's domain-records, falls within said partition range, wherein said functions can be applied to the values of same and/or different attributes.

6. The method of claim 5, wherein a said attribute that is associated to said one or more range partition based attribute-keys will itself be associated to a set of consecutive non-overlapping range partitions, wherein said pre-defined statistical functions using for qualifying said attribute-key values include, but not limited to, sum, count, average, and other complex functions.

7. The method of claims 4 and 5, wherein the same range partition defined for an attribute-key can be defined and created in both said originating and said referenced domain based on their respective associated domain-records, wherein segments from said originating domain can be converted to respective segments in said referenced domain.

8. The method of claim 7, wherein for a segment created for a range partition in originating domain, each of its bit “1” represents one occurrence of its corresponding attribute's distinct value satisfying said pre-defined criteria with respect to its range partition, wherein for a said corresponding converted segment, each of its bit “1” corresponds to said corresponding attribute's distinct value from said originating domain, wherein a direct reference can be created from said segment of the originating domain to its corresponding converted segment of the referenced domain, wherein said converted segment can be used as an index for looking up said originating domain's attribute-key's set of qualified attribute values.

9. The method of claim 1, wherein for a said type of attribute-key that corresponds to a defined value, its corresponding segment is created to associate to either a pre-defined subset or all of its domain's domain-records, wherein said segment hereon is referred as a “control” segment, wherein for a said control segment that is associated to all of domain's domain-records hereon is referred as a “signature” segment, wherein new versions of said signature segments are created to reflect the net existing domain-records of said domain, wherein analyses required applying to all of domain's domain-records can perform Set operations among the required segments and required said version of signature segment.

10. The method of claim 9, wherein is further including a method of inserting new data records to a domain, wherein said new records are conforming to said domain's attribute structure, comprising:
creating new key-value pairs for said new data records using the same unique key generation method;
creating a new temporarily control segment based on said new set of domain-records;
creating a new signature segment that reflects the combined set of data records by performing a Set operation UNION (“OR” bit-wise) between the current signature segment and said new temporarily control segment.

11. The method of claim 10, wherein is further including a method of deleting specified domain-records from a domain, comprising:
creating a new temporarily control segment based on said specified domain-records to be deleted;
creating the new signature segment that reflects the net set of domain-records after deleting by performing a Set operation MINUS (“MINUS” bit-wise operations) between the current signature segment and said new temporarily control segment.

12. The method of claim 1, wherein a domain can be associated with one or more child domains, wherein each said child domain has same attribute structure as its parent and contains its own independent set of domain-records, wherein a said child domain hereon is referred as a “sub-domain”, wherein a parent domain can distribute its source data records based on pre-defined criteria to one or more of its sub-domains and creating new sub-domains as required, wherein a hierarchy of multiple levels of parent domain to sub-domains can be created, wherein a said sub-domain generates its own range of domain-keys independent of other sub-domains, or it adheres to the specific range of values assigned by its parent, wherein all segments for a sub-domain are created based on its own set of domain-keys.

13. The method of claim 12, is further including a method of combing two or more sub-domains into a single domain for analyses that require performing Set operations against the combined set of data, wherein said list of sub-domains to be combined has a defined order sequence, comprising:
starting from second till the last signature segment in the list, up-shifting, or incrementing, all bits in each respective signature segment by an offset value equals to the maximum bit position value of its immediate previous signature segment that has been up-shifted or otherwise use the original non-shifted if not applicable, such as the first segment;
then performing Set operation UNION (“OR” bit-wise) among the signature segments, starting from the first non-shifted through each in-between till the last up-shifted signature segment, to generate the final signature segment that reflects the combined sub-domains.

14. The method of claims 12 and 13, wherein a said combined segment, which could have been modified by subsequent Set operations, can be converted back to be compatible with its respective sub-domains with a method that is comprising:
creating a new segment for each sub-domain and copying to said new segment all bits within the respective range for the corresponding sub-domain from said combined segment;
down-shifting, or decrementing, all bits in each said new segment by the same offset value that was used previously for combining the segment of this sub-domain to said final combined segment.

15. The method of claims 13 and 14, wherein same method is used to up-shift and down-shift any set of respective segments of any types of attribute-keys from said list of sub-domains for combining to a single domain and converting back to its respective sub-domains, wherein up-shift offset values are based on corresponding sub-domains' signature segments after each has been up-shifted, except for the first signature segment in the list where up-shifting is not applicable and therefore not applied.

16. The method of claim 1, is further including a method of multi-level drill-down data analyses, wherein a selected attribute-key is profiled by another selected set of attribute-keys, wherein said attribute-keys herein are referred as “target-key” and “source-keys”, respectively, comprising:
performing required Set operations between said target-key's segment and each of source-key's segment to generate respective result segments, wherein each said result segment's bit “1” count provides a numeric score and analyses can be performed based on said score individually and/or among all scores collectively, using them as, but not limited to, ranking or weighting factors.
continue next level of drill-down, if applicable, by selecting a result segment that is required for drill-down and using it as the target-key's segment and repeat above same process with another selected set of source-keys.

17. The method of claim 16, wherein additional analyses can be based on the final scores generated by its corresponding end-to-end paths, wherein a said path is traced starting from target-key's segment and through all intermediate result segments to said final result segment, wherein all said end-to-end paths with all its respective segments can be saved to disk based file system and retrieved for viewing, modifying existing drill-down paths, and/or creating new extensions to existing drill-down paths.

18. The method of claim 1, is further including a method of performing Set operations among a list of segments in parallel by a plurality of processors, comprising:
grouping segments from said list in appropriate pairs for their respective Set operations;
creating a plurality of processing threads via a plurality of processors for executing said Set operations for respective groups in parallel, wherein a result segment is generated by said Set operation for each said group;
adding said result segments to a new list; also adding to said new list any left-over un-paired segment from previous list;
repeat above process for next around of processing, if required, by grouping said result segments in said new list in appropriate pairs and executing their respective Set operations till a final result segment is generated.

19. The method of claim 18, wherein said processing is performed in stages, wherein the initial stage having a static list of segments and all subsequent stages having result segments arriving in an asynchronous manner, wherein for each processing stage, new concurrent processing threads will be created to process the Set operation for each pair of segments after they have arrived and are ready to be processed.
